(19) United States
(12) Patent Application Publication
(10) Pub. No.: US 2022/0152646 A1
(43) Pub. Date: May 19, 2022

(54) SEALANT DISPENSER AND METHODS OF OPERATION

(71) Applicant: Firestone Building Products Company, LLC, Nashville, TN (US)

(72) Inventors: Larry C. BARTON, Franklin, TN (US); Michael J. HUBBARD, Goshen, IN (US); Russell K. GLOWNER, Indianapolis, IN (US)

(21) Appl. No.: 17/438,729

(22) PCT Filed: Mar. 12, 2020
(86) PCT No.: PCT/US2020/022282

§ 371 Date: Sep. 13, 2021

Related U.S. Application Data
(60) Provisional application No. 62/884,445, filed on Aug. 8, 2019.
(60) Provisional application No. 62/845,605, filed on May 9, 2019.
(60) Provisional application No. 62/817,745, filed on Mar. 13, 2019.

(51) Int. Cl. B05C 11/10; B05B 9/00; B05B 9/06; B05B 12/12; B05C 5/02; E04D 15/07

(52) U.S. Cl. CPC B05C 11/1021; B05B 9/007; E04D 15/07; B05B 12/122; B05C 5/0216; B05B 9/06

(57) ABSTRACT

A sealant dispenser comprising a chassis adapted to carry a supply of sealant dispensable through a nozzle; at least one drive wheel to directionally propel said chassis; and a detection system carried by said chassis to determine a location to dispense sealant through said nozzle and controlling direction of said at least one drive wheel to position said nozzle.

### FIELD OF THE INVENTION

The present invention is directed to sealant dispensers for dispensing a sealant such as a caulk or adhesive. Specifically, the present invention is directed to a sealant dispenser that monitors an area where sealant is to be dispensed and automatically adjusts its position to ensure that the sealant is dispensed where desired.

### BACKGROUND OF THE INVENTION

It is well known to use a sealant or caulk to adhere similar or dissimilar materials to one another, and more specifically to ensure that the two adjacent connected pieces of material provide a secure, water-tight or air-tight seal at their connection point. More importantly, the sealant ensures that the entire periphery or boundary between the two connected materials is sealed so as to prevent contaminants from entering through the connection point.

Sealant may be applied by hand or by using a hand-held caulking gun for the short lengths that materials need to be sealed with respect to one another. However, such hand-held devices are not suitable for longer connection lengths. This is because the operator gets tired and does not always make a secure seal or bond between the two materials to be connected. It is also known to use automated caulk guns but these processes still rely on the user to maintain a steady hand so as to ensure a uniform seal between the two pieces of material being connected. Moreover, use of an automated caulk gun may still not be suitable for use in longer length connections, i.e., those over ten feet long, due to misalignment or other variables.

To address such shortcomings, it is known to use a wheeled cart so as to allow for controlled dispensing of sealant. These are known for their stated purpose, which is to secure one item to another, but they are not necessarily utilized to ensure a seal between two parts. Moreover, current systems are problematic in ensuring that the right amount of sealant is used and the seal is placed where most effective. If not enough sealant is dispensed or improperly placed a poor seal results. Dispensing too much sealant is wasteful and can interfere by adhering to other areas of the connecting pieces where it is not desired. And such systems are still prone to many types of human error. Indeed, skilled artisans will appreciate the difficulty of applying a sealant bead to an edge of a membrane disposed on another membrane, as commonly found in roofing applications.

Therefore, there is a need in the art for a sealant dispenser that is at least partially autonomous to deliver a sealant between two membranes or other pieces of material that are to be connected to one another. There is also a need for a sealant dispenser that can automatically adjust its position to accommodate deviations in where the sealant is to be placed. There is also a need for a dispenser to apply sealant in lengths of up to one hundred feet or longer. And there is a need for such sealant dispensers to control the rate the sealant is applied to the materials to be connected to one another.

### SUMMARY OF THE INVENTION

One or more embodiments of the present invention provide a sealant dispenser comprising a chassis adapted to carry a supply of sealant dispensable through a nozzle; at least one drive wheel to directionally propel said chassis; and a detection system carried by said chassis to determine a location to dispense sealant through said nozzle and controlling direction of said at least one drive wheel to position said nozzle.

Yet other embodiments of the present invention provide a method for dispensing sealant, comprising observing with a detection system a phenomenon in an area that receives a sealant; automatically moving a chassis that carries the sealant; and dispensing the sealant in the area by automatically moving said chassis relative to the observed phenomenon.

Still other embodiments of the present invention provide a method for dispensing a sealant, comprising observing with a detection system a phenomenon in an area that receives a sealant; automatically moving a chassis that carries the sealant based on a signal generated by said detection system; and automatically moving a nozzle that dispenses the sealant based on the signal generated by said detection system.

### BRIEF DESCRIPTION OF THE DRAWINGS

For a complete understanding of the objects, techniques and structure of the invention, reference should be made to the following detailed description and accompanying drawings, wherein:

FIG. 1 is a side elevational view of a sealant dispenser according to the concepts of the present invention;

FIG. 2 is a partial bottom perspective view of the sealant dispenser according to the concepts of the present invention;

FIG. 3 is a top plan view of a dispensing system utilized in the sealant dispenser according to the concepts of the present invention;

FIG. 4 is a side elevational view, partially broken away, of an alternative sealant dispenser according to the concepts of the present invention;

FIG. 5 is a partial bottom perspective view of the alternative sealant dispenser according to the concepts of the present invention;

FIG. 6 is a top plan view of the alternative sealant dispenser according to the concepts of the present invention;

FIG. 7 is a perspective view of a user input associated with the sealant dispenser according to the concepts of the present invention; and

FIG. 8 is a schematic representation of two membranes connected and sealed to one another by utilizing the sealant dispenser according to the concepts of the present invention.

### DETAILED DESCRIPTION OF ILLUSTRATIVE EMBODIMENTS

### Introduction

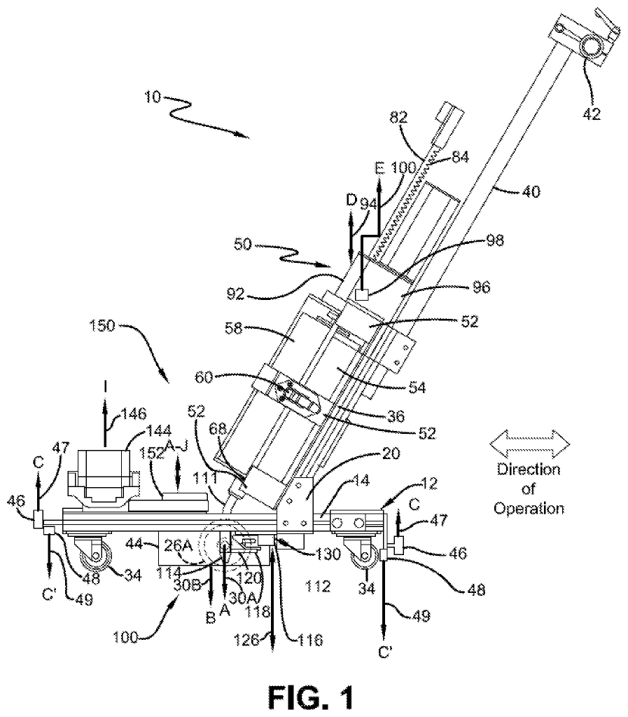

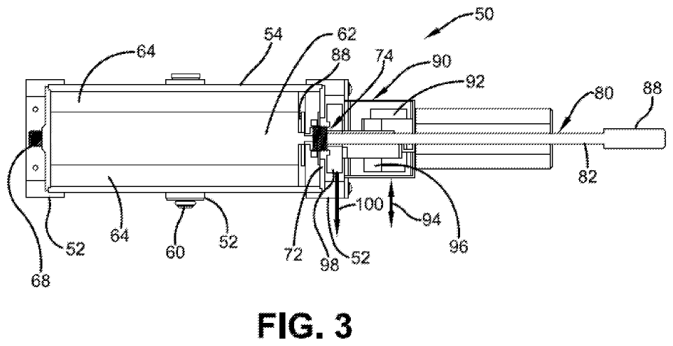

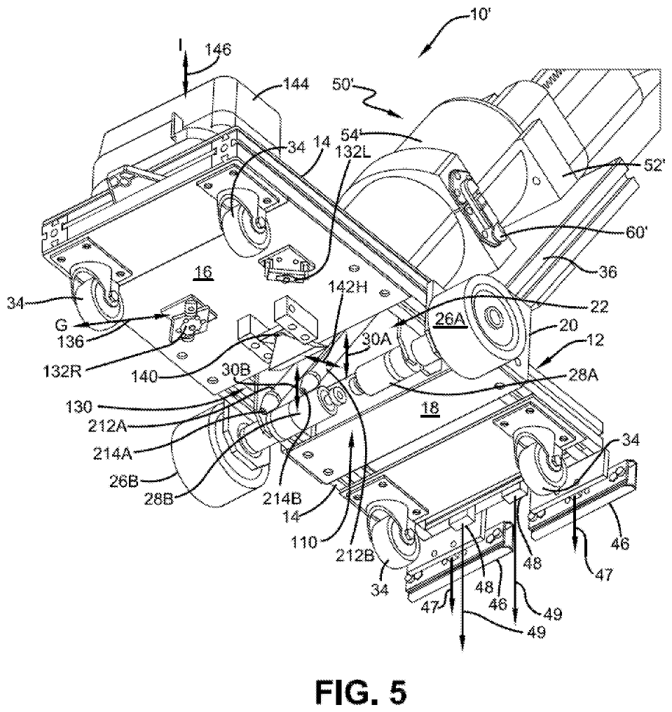

Referring now to the drawings and in particular to FIGS. 1-6, it can be seen that sealant dispensers according to the concepts of the present invention are designated generally by the numeral 10 and 10′. Generally, the dispensers 10 and 10′ are utilized to apply a sealant, caulk, or other adhesive between two or more pieces of material to be connected to one another. In the present embodiments, the sealant dispensers may be utilized to connect two sheets of polymeric material, commonly referred to as membranes, to one another, such as is commonly done in sealing a roof system. In the present embodiments, the dispenser lays down a bead of sealant along an edge of one membrane that is positioned on top of another membrane. Skilled artisans will appreciate that the dispensers may be utilized with other embodiments so as to connect other types of material to one another in an automated manner. Indeed, the sealant dispensers 10 and 10′ may be configured so as to provide a chassis that is adapted to carry a supply of sealant that is dispensable through a nozzle. At least one drive wheel may be associated with the chassis which is utilized to directionally propel the chassis along the membrane or other materials which are to be connected to one another, or on a surface in proximity to the materials to be sealed. The dispensers may provide for a detection system that is carried by the chassis to determine a location of where to dispense the sealant through the nozzle. The detection system may also provide a way of controlling the direction of the at least one drive wheel so as to position the nozzle with respect to the sealant deposit location. The dispensers may also provide for a nozzle position system that is carried by the chassis in such a way that the nozzle position system receives input from the detection system to control position of the nozzle while the at least one drive wheel propels the chassis. Skilled artisans will appreciate that the sealant dispensers may be modified as needed in order to accomplish the desired goal of sealing at least two pieces of material to one another or connecting the pieces of material to one another. The dispensers 10 and 10′ disclosed herein are at least distinguishable from one another in the way the sealant material is dispensed. It will be appreciated that features and components of one dispenser may be utilized on the other dispenser.

The sealant dispenser 10 provides for a chassis 12 which provides for spaced apart side rails 14 which may be of substantially the same length. Connecting the side rails 14 to one another may be a mount plate 16 which is utilized to support and carry various components of the dispenser as will be described. In a similar manner, a mount bracket 18 may also be utilized to connect the spaced apart side rails 14 to one another. The mount bracket 18 may provide for upwardly extending sides 20 which further serve to allow for attachment of components associated with the dispenser 10. The side rails 14, the mount plate 16, and the mount bracket 18 may be spaced apart from one another in such a manner so as to form a mount opening 22 therebetween.

Secured and extending from an underside of the chassis 12, and in particular the side rails 14, may be respective drive wheels 26A and 26B. The drive wheels are coupled to corresponding drive motors 28A and 28B wherein each drive motor independently operates its respective drive wheel. The drive wheels extend underneath the frame and support the side rails. In some embodiments the drive wheels 26 may extend laterally away from the side rails or they may be positioned underneath the chassis. Laterally extending wheels may allow the dispenser 10 to better accommodate movement along sloped surfaces. In some embodiments the drive wheels may be mounted at about a mid-point of the chassis 12, but other embodiments may position the drive wheels at the front end or rear end of the chassis. In the present embodiment the drive wheels are driven only in a single direction, but in some embodiments they may be driven in both directions. And in other embodiments, the drive wheels may be driven in opposite directions. For example, drive wheel 26A may be rotated in a forward direction, and the other drive 26B wheel may be rotated in a rearward direction, or vice versa. Such a feature will allow the dispenser to make sharper turns. Skilled artisans will further appreciate that the drive wheels that operate in only a single direction are clutched so as to ensure rotation in only a single direction. Other embodiments may not employ clutched drive wheels. Each drive motor 28A and 28B receives a corresponding input drive signal 30A and 30B wherein the input drive signals, designated by the capital letters A and B respectively, are generated by a controller as will be discussed in detail as the description proceeds. In some embodiments, only a single drive wheel and motor may be employed and in other embodiments three or more drive wheels with corresponding motors may be employed. In any of the embodiments disclosed, each of the wheels may be driven at different speeds in the same or different directions to enhance operational control of the dispenser. Of course, other propulsion mechanisms could be utilized.

In some embodiments, as noted above, a two-wheel differential speed steering system may be employed, wherein the drive and steering are directly coupled. Each drive wheel 26 may have an independent DC gear motor 28 with an integral encoder. A system controller (to be discussed) provides independent pulse width modulation (PWM) inputs to the motors to control their speed. To steer the chassis, one motor may be spun faster than the other. Since the chassis is moving during operation, steering involves speeding up one wheel while maintaining the nominal travel speed of the other. Neither motor is ever controlled to spin slower than nominal speed. In some embodiments, each drive wheel may have an independent feedback controller (provided by an encoder mounted on the back side of the motor) to regulate its velocity. Accordingly, each motor may have a gearbox to improve the torque produced by the motor on the opposite side, which also reduces the speed of the output shaft. Skilled artisans will also appreciate that each drive wheel may be mounted to its respective drive motor via an overrunning or freewheel clutch. Such a clutch allows freewheeling in one direction only. As a result, clutches allow an operator to freely pull or push the dispenser in the drive direction without putting any strain on the motors or their integral gear boxes. This feature allows the operator to manually transport and position the dispenser between dispensing operations. However, in some embodiments, the ability to manually push/pull and position the dispenser 10 may be a desired feature; therefore, some embodiments may employ active clutches (or brakes) that can be engaged or disengaged manually or automatically during driving/dispensing. In other embodiments, a single drive wheel with a drive motor may be used, wherein the single drive wheel may include a steering mechanism.

One or more wheels 34 may be used to support each end corner of the chassis. Skilled artisans will appreciate that the wheels 34 may be widely spaced to avoid incidental contact with the dispensed sealant that passes between them during operation. The wheels 34 may be a swivel caster which incorporates a spring-type suspension to allow for vertical travel to accommodate small obstructions and/or sloped surfaces. In embodiments where caster wheels 34 extend from each corner of the chassis, the drive wheels do not include a clutch. Accordingly, if the user desires to move the dispenser, the dispenser is tilted or leaned so that only two of the caster wheels are supported by a surface, to allow for pushing or pulling of the dispenser in the desired direction. In some embodiments, the wheels 34 may be something other than caster wheels—driven or undriven—and may be used to support the chassis and enhance operation of the dispenser. Other types of suspension configurations may be employed. In some embodiments, a more elaborate suspension system may interact with the drive wheels and also with the detection and nozzle position systems as needed. In other embodiments, the drive wheels may provide the needed support for the chassis, thus eliminating the need for the trailer wheels 34.

Supported by the mount bracket sides 20 and the mount bracket 18 may be a dispenser mount 36 which angularly extends from the mount bracket 18 at an angle anywhere from between 30° to 90° with respect to the side rails 14. In the present embodiment, the dispenser mount 36 is oriented at an angle of about 60°. In the present configuration the direction of operation of the sealant dispenser 10 is in the same angular direction of the dispenser mount. However, skilled artisans will appreciate that the direction of operation may be in the opposite direction depending on a particular end use and the rotational direction of the drive wheels.

Extending from the dispenser mount 36 is an upright handle 40 which may be angularly configured in about the same direction as the dispenser mount. However, other embodiments may employ a slightly different angular orientation of the handle 40. The handle 40 may have perpendicularly extending hand grips 42 or they may be oriented in another angle as appropriate. In other embodiments, the handle 40 may not be provided or could be replaced with a carrying handle or handles extending from the chassis.

In some embodiments a side shroud 44 may extend downwardly from one or more respective side rails 14 so as to protect and facilitate detection of the area where sealant is dispensed and for other purposes as will be discussed as the description proceeds. Skilled artisans will appreciate that the side shrouds prevent debris from coming in contact with sealant as it is dispensed. The shrouds 44 will be sized so as to not interfere with the travel of the chassis.

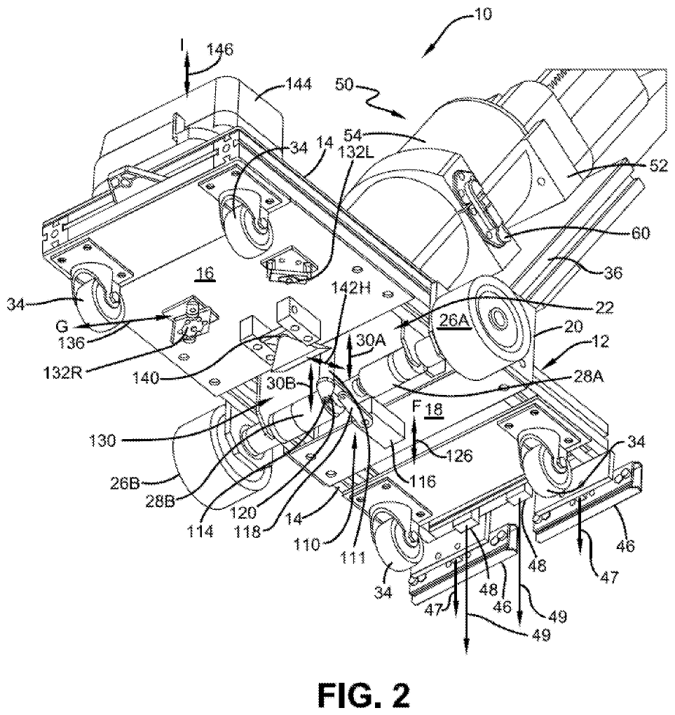

Extending from at least one end of the chassis 12 may be at least one bumper/cliff sensor 46 which may be employed to detect the presence of an object in the direction of the dispenser's travel. If an object is present in the direction of operation and engages the bumper/cliff sensors 46 so as to detect an interfering force, a bump signal 47 is generated for receipt by the controller as will be discussed. The bump signal 47 may also be designated as capital letter C. Extending downwardly from one or both ends of the chassis 12 may be one or more cliff/bumper sensors 48 which may be employed to detect any unexpected or sharp drops. In other words, the sensors 48 may detect a sudden drop of the chassis and generate a drop signal 49 (designated as signal C′). Receipt of such a signal by the controller from either the bump or cliff sensors will result in stoppage of the drive wheels and cessation of all dispensing operations. Skilled artisans will appreciate that the sensors 46 and 48 may perform one or both object detection and drop detection functions depending on the direction of travel of the dispenser. The embodiment of the dispenser shown in FIG. 1 shows sensors 46 and 48 at both ends of the chassis. The embodiment shown in FIG. 2 shows the sensors 46 and 48 at only one end of the chassis, but skilled artisans will appreciate that the sensors 46 and 48 may only be disposed at the other end.

Referring now to FIGS. 1-3, it can be seen that a dispensing system 50 may be mounted on the sealant dispenser 10 and, in particular to the dispenser mount 36. The dispensing system may provide a number of mount collars 52 which are utilized to carry a sealant chamber 54. The sealant chamber 54 may include a hinged door 58 which is secured to the chamber 54 by a latch or other mechanism. Skilled artisans will appreciate that other configurations of a sealant chamber 54 may be employed depending upon the size of the supply of sealant to be associated with the dispenser. In the present embodiment a chub 62 is received in the sealant chamber 54. In the present embodiment, the chub is a supply of sealant wrapped in a polymeric or other similar type of material which is about 2″ in diameter and about 9.5″ long. Of course other size chubs may be received in the chamber 54 as appropriate by the sealant dispenser's end use. In some embodiments spacers 64 may be utilized to keep the chub 62 centered and well positioned within the chamber 54. Other embodiments of the chamber 54 may be adapted to receive caulk tubes of various different sizes depending on the application. Caulk tubes may be replaced when the sealant has been fully expelled and when only a small amount of sealant is needed to complete an installation of a roof system. At one end of the chamber 54 is a chamber nozzle mount 68 which may be threaded or otherwise configured. At an opposite end of the chamber nozzle mount 68, the sealant chamber 54 may provide for a chamber plunger end 72 which has a plunger opening 74 extending therethrough.

A plunger assembly 80 may be associated with the dispensing system 50 and may be coupled to the chamber plunger end 72. The plunger assembly 80 may provide for a rack 82 which at one end extends through the plunger opening 74. The rack 82 may provide for a plurality of rack teeth 84 along one edge of the rack or may provide other structural features that allow for axial movement of the rack 82 with respect to the sealant chamber 54. A plunger disc 86 may be secured to one end of the rack 82 and is positioned within the sealant chamber 54. The disc 86 may have a flexible scraper feature to ensure that all the available material is dispensed from the chamber 54. At an opposite end of the plunger disc 86 the rack 82 may provide a rack handle 88 which allows for manual retraction of the rack 82 in a manner similar to hand-held caulk guns.

Associated with the plunger assembly 80 and the sealant chamber 54 may be a plunger housing 90 wherein in the embodiment shown the plunger housing 90 is positioned at the chamber plunger end 72. The plunger housing 90 may contain a plunger motor 92 which may be in the form of a linear actuator or other motorized component which is operated by a plunger motor signal 94, also designated by the capital letter D in the drawings. Associated with the plunger motor 92 is a plunger transmission 96 wherein the transmission may be driven by the plunger motor and engages the rack teeth 84. Accordingly, when an appropriate signal is received, the plunger motor 92 engages the transmission 92 so as to linearly move the plunger assembly 80. A dispensing rate of the sealant may be controlled by adjusting the amount of voltage applied to the plunger motor. The amount of voltage applied may also be adjusted according to travel speed generated by the drive wheels. In any event, when the plunger assembly moves, the rack 82 moves the plunger disc 86 so as to engage the chub 62 and expel the caulk or sealant material out the chamber nozzle mount 68. In some embodiments a linear encoder 98 may be employed and associated with the plunger transmission 96 and/or the rack 82 so as to track the position of the rack to confirm movement of the plunger disc 86 and gauge its travel and, accordingly, the amount of material that is being dispensed at any given time. The linear encoder generates a linear encoder signal 100, also designated as signal E in the drawings, for receipt by the controller. When the encoder reaches a predetermined position near the bottom of the tube, which is indicative of an empty tube, the signal 100 is sent to the controller to stop operation of the dispenser. In some embodiments, the user may be able to adjust an input that allows for calibration and/or adjustment of the sealant bead size dispensed based on physical and/or environmental factors. Skilled artisans will appreciate that the dispensing system 50 may be adapted to dispense sealant from any type of appropriate container. At a minimum, the system 50 will carry sufficient quantities of material to dispense material over extended lengths of membranes and in a controlled manner according to other inputs received from other components of the dispenser.

Referring now to FIG. 2, it can be seen that a nozzle position system is designated generally by the numeral 110 and may be mounted to an underside of the mount bracket 18. The nozzle position system 110 may include a piece of flexible polymeric tubing 111, which has one end connected to the chamber nozzle mount 68 of the sealant chamber 54, wherein this may be a threaded connection. An opposite end of the tubing 111 may provide a nozzle 112, which may provide for a narrowed tip 114, which may be replaceable and which expels the sealant dependent upon the rate of travel of the rack 82 and the material properties of the sealant material. In some embodiments a cap may be placed in the tip to prevent the sealant material from drying out when the dispenser is not being used.

The position system 110 may also provide for a rotary position motor 116 which in the present embodiment is shown to be connected to the underside of the mount bracket 18, but which may be carried in any fashion deemed appropriate. In any event, the position motor 116 drives a nozzle linkage 118, wherein an opposite end of the linkage 118 provides a collar 120 that fits around the tip 114 so as to adjust its position in relation to the chassis. The nozzle tip 114 may clip into a fixture attached to the arm or “horn” of the motor 116. The collar 120 is designed to hold the nozzle tip so that dispensed sealant exits the nozzle substantially vertically in relation to the membrane. The linkage 118 swings about a vertical axis to precisely position the nozzle tip based on the serial data feed from the detection system 130 as will be discussed. The response of the motor 116 is relatively faster and more precise compared to the control of the drive wheels. However, the range of the linkage is limited to about ½ inch in each direction. This range may be increased with a longer linkage. In some embodiments a servo-based linear motor may be employed instead of a rotary position motor which will allow for increased range and improved precision of the nozzle tip positioning. As a result, the nozzle will no longer “swing” in an arced path but rather “sweep” side to side. The position motor 116 receives a nozzle position motor signal 126 which is received from the controller and is designated by signal F in the drawings.

The sealant dispenser 10 may also provide for a membrane seam detection system 130 as shown in FIG. 2. The system 130 employs at least one light 132 which may be mounted to the underside of the mount plate 16 or other portion of the chassis. Skilled artisans will appreciate that multiple lights 132 may be employed so as to illuminate the area in which the sealant material is to be dispensed. In the present embodiment a light 132L may be disposed on the left side of the chassis and a light 132R on the right side of the chassis. Although the present embodiment employs lights so as to generate a shadow, which will generally be referred to as a phenomenon, skilled artisans will appreciate that other types of phenomenon may be generated so as to highlight an area where the sealant is to be dispensed with respect to the membranes or other components which are to be joined together. Indeed, in some embodiments touch sensors or proximity sensors may be employed to detect the area to be sealed. Other phenomenon may include, but is not limited to, tactile, temperature, and hardness to name a few. In any event, the lights 132 are operated by a light signal 136, designated as capital letter G in the drawings.

As noted above, illumination of the light 132 is directed so that the light is shown across the top of the lap joint edge in a small area beneath the chassis. This light washes out all shadows created by any ambient light and creates a sharp shadow at the base of the lap joint edge where the sealant material is to be dispensed. As will be described in further detail below, the user may selectively designate which light is to be illuminated so as to facilitate generation of the shadow.

Also associated with the membrane seam detection system 130 is a camera 140 which may be mounted to the underside of the mount plate 16 and which has a field of view directed toward the two component parts or membranes which are to be joined to one another. As a result, the camera is able to generate a vision signal 142, designated by capital letter H, so as to observe the phenomenon, which in the present embodiment is a shadow generated by a difference in the height of the membranes to be connected to one another. Skilled artisans will thus appreciate that the lights will be directed toward the members to be connected to one another so as to facilitate or enhance the formation of the shadow or other phenomenon which indicates where the membranes are to be connected to one another and also to indicate where the sealant material is to be dispensed. In some embodiments the camera 140 may be a digital camera which identifies an edge of the shadow and characterizes the position and angle of the edge within the camera's view frame. In the present embodiment the lights are positioned near the front of the frame (in the direction of travel) and pointing toward the back and center of the frame. The camera is positioned near the center followed by the dispensing mechanism. It has been found that as the dispenser is moving along the edge of the membrane to be sealed, a patch or some other discontinuity in the edge may be encountered. Placing the lights and the camera ahead of the dispensing mechanism allows the controller (to be discussed) to recognize there is no longer an edge and to stop the dispensing of the material on to the membranes. It will further be appreciated that the lights 132 and the camera 140 may be positionally adjusted with respect to one another on the chassis, mount plate 16, and/or the mount bracket 18 so as to optimize generation of the shadow generated by the different heights of the membranes to be sealed to one another.

Skilled artisans will appreciate that the travel direction of the dispenser 10 as controlled by the drive wheels may change a position of the nozzle position system 110 with respect to a position of the membrane seam detection system 130. Accordingly, in some embodiments, the position system 110 may be mounted in a leading position in the direction of the dispenser's travel and the detection system 130 in a trailing position. In other embodiments, the systems 110 and 130 may be reversed.

A power supply 144 may be mounted on the chassis 12 and is positioned in such a manner so as to balance the weight of the other components carried by the chassis. In the present embodiment the power supply is an 18 v 300 mAh lithium ion battery. Of course, other size or types of batteries may be employed to power all the components associated with the dispenser. In some embodiments, the battery provides enough charge to allow for depositing sealant up to 3000′ in length. In any event, the power supply 144 generates a power supply signal 146 which is delivered and routed to the component parts of the dispenser which require electrical power. The power supply signal 146 may also be designated by the letter I.

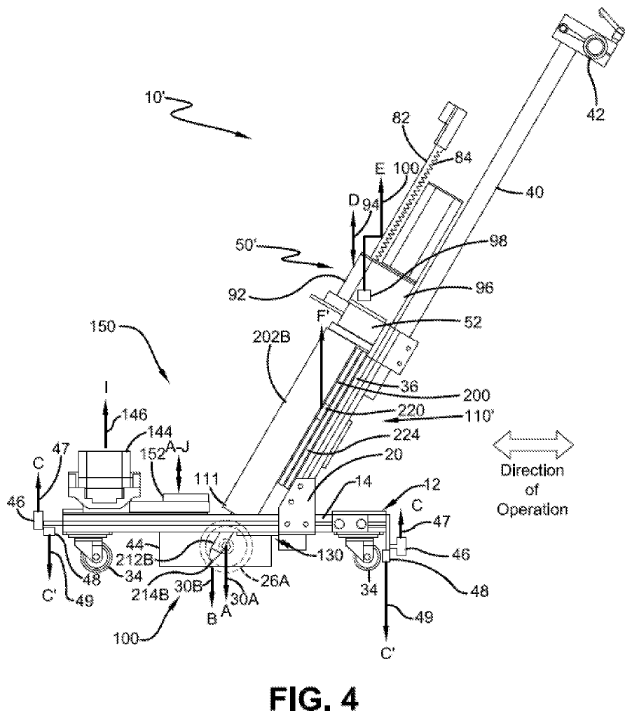

Referring now to FIGS. 4-6, it can be seen that an alternative dispenser is designated generally by the numeral 10′. The significant difference between the dispenser 10 and dispenser 10′ is the use of an alternative nozzle position system designated by the numeral 110′. Generally, the nozzle position system 110′ is utilized with caulk tubes instead of a chub. Generally, the use of the caulk tubes avoids the need to clean the polymeric tubing 111 utilized to interconnect the chub to the nozzle which dispenses the sealant material. In any event the dispenser 10′ provides many of the same components as the dispenser 10 for use with the nozzle position system 110′. The components associated with the nozzle position system 110′ are substantially the same in regard to the interrelationship with the dispensing system.

In FIGS. 4-6 the dispensing system is designated generally by the numeral 50′ and comprises a mount collar 52′, a sealant chamber 54′, a hinged door 58′ and a latch 60′ which are functionally the same as disclosed in the embodiment shown in FIGS. 1-3. The dispensing system 50′ does not require the chub 62, the spacers 64, or the chamber nozzle mount 68 as a result of modifications needed to incorporate the nozzle position system 110′ with the dispensing system 50′. Otherwise, most all of the other components associated with the dispensing system 50′ are substantially the same.

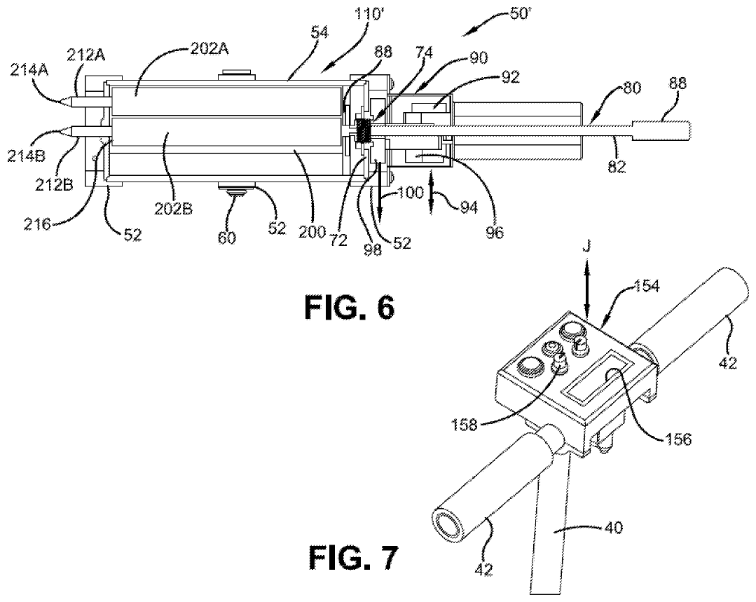

As best seen in FIGS. 4 and 6, the nozzle position system 110′ includes a carriage 200, which may be carried by the sealant chamber 54′ or carried as appropriate and which may hold at least two caulk tubes 202A,B. Skilled artisans will appreciate that a single tube 202 may be held or more than two tubes may be held with a properly configured carriage 200. Each caulk tube 202 includes a nozzle 212 which may be terminated a tip 214 from which the sealant material exits. The sealant chamber 54′ may include a chamber slot 216 at an end opposite the plunger assembly 80. The slot 216 is sized to allow for the nozzles 212 to be moved side to side at the appropriate time. The slot 216 may also provide structural support to the nozzles as needed.

The system 110′ may include a position motor 220, which may be supported by the dispenser mount 36. In the present embodiment the motor 220 may be in the form of a linear actuator which is controlled by a motor signal 222 and which is designated as signal F′. Receipt of such a signal by the controller from the position motor 220 allows for control of when a selected tube is to be associated with the plunger assembly 80. Accordingly, when one tube is exhausted, the plunger assembly 80 is actuated so as to retract the plunger disc 86 from within the caulk tube so that the tube may be moved aside for receipt of the next caulk tube to be used. In any event, the position motor 220 is operatively connected to a tray 224 which supports the carriage 200. Accordingly, at the appropriate time, the controller 152 may be actuated so as to move one tube out of position so that the next tube may be moved into position for dispensing. It will be appreciated that the non-dispensing caulk tube or tubes may be positioned so as to not interfere with operation of the dispenser. In the embodiment shown, the caulk tubes are positioned side-by-side. Skilled artisans will appreciate that in another embodiment the tubes may be positioned in a fore-aft relationship. That is, one tube may be stacked on top of the other. Regardless of the configuration of the tubes, each tube may be associated with a corresponding plunger assembly 80 with a separate operating motor 92 and associated plunger disc 86. In operation the tubes stay in place and the controller stops running one motor and starts running the other when material is exhausted, or near exhaustion, from the first tube. In such situations, there may be a slight stoppage of dispensing, but such stoppage may be coordinated by the controller. If dispensing is continuous between the two tubes, there may be overlap of the sealant material. The configuration of the tubes may allow for sufficient time to start up the second motor to prime the sealant in the second tube for dispensing. Operation of the nozzle position system 110′ in conjunction with the other components of the dispenser 10′ is discussed below.

Referring now to FIGS. 1, 4 and 7, it can be seen that a control system of either sealant dispenser is designated generally by the numeral 150. The control system 150 provides for a controller 152 which may be carried by the mount plate 16 or by the handle 40 or any other suitable place on the dispenser. The controller 152 provides the necessary hardware, software, and memory for communicating with the various components of the sealant dispenser, such as receiving inputs, generating outputs, and processing the information received or generated to facilitate operation of the dispenser. The controller 152 may be implemented on an Arduino Mega 2560, which is an open-source commercial programmable microcontroller. The controller 152 may receive user input 154, designated by the capital letter J, as provided by the buttons and switches carried by the handle 40 and grips 42 for the purpose of designating a speed of the chassis (such as low, medium, or fast) which controls the overall speed of the dispenser, a target distance so as to allow for autonomous operation of the dispenser 10, a dispense rate which controls the amount of sealant dispensed as the dispenser operates, and other features deemed suitable to control operation of the dispenser. In some embodiments, the only input needed from the user may be the distance the dispenser 10 needs to travel to complete dispensing of the sealing material. In such an embodiment, the other required input from the dispenser may be detection of which side of the membrane is positioned relative to the other, and/or the speed the dispenser is traveling. A display 156 may be carried by the handle 40 and/or the grips 42 and associated with the user input 154 and/or the controller 152 so as to effectively communicate with the technician. A run/stop switch 158 may be associated with the user input 154 so as to control operation and provide any other functions that are appropriate. The signals A-J are received and/or sent by the controller 152 as noted above, but other signals may be generated or sent to control operation of other components used with the dispensers.

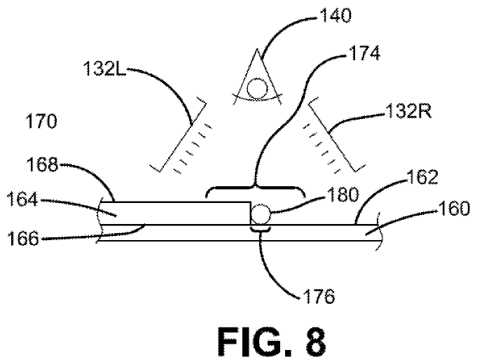

Referring now to FIG. 8, it can be seen that a base membrane is designated generally by the numeral 160, which has a top surface 162. In the present embodiment the membranes disclosed are EPDM and may be self-adhesive, although skilled artisans will appreciate that other materials may be utilized with the system. Disposed on the base membrane 160 is a cover membrane 164 which provides for a bottom surface 166 that is placed on the top surface 162 of the base membrane. The cover membrane 164 is typically arranged with a 3″ to 4″ overlap on the adjacent base membrane 160. The cover membrane 164 provides for a top surface 168 wherein the surfaces 166 and 168 are connected to one another by an edge 170. The dispenser 10, and in particular the detection system, is able to detect height differences of between 0.040″ to 0.090″. But modifications may be made to detect differences as small as 0.005″. In other words, the dispenser's detection system can accommodate or detect a thickness of the cover membrane 164 as small as 0.005″. Large thicknesses of the membrane over 0.090″ or more may also be detected, but in some instances, modifications may need to be made to the chassis and/or drive wheels to accommodate such large thicknesses.

In operation, the dispenser 10, 10′ is positioned so as to generally straddle the two membranes to be connected to one another. However, it will be appreciated that the chassis may be supported on a surface which is not one of the surfaces to be connected or sealed. Concurrently therewith, the user or technician will input various parameters prior to initiating operation of the dispenser. These parameters may include, but are not limited to: the distance of the seam to be used to join the membranes to one another, the speed of the dispenser (fast, medium, slow), the rate at which the sealant is to be dispensed, and the like. Next, the light 132L (left) and the light 132R (right) are directed at the edge 170 and in particular a viewing area 174. Illumination of the viewing area 174 and the membranes 160 and 164 is generated in such a manner that the edge 170 generates a shadow 176 which may also be referred to as a phenomenon. The shadow 176 is detected by the membrane seam detection system 130 and in particular the camera 140. In one embodiment, the user is able to designate through the user input 154 which side of the chassis is on the “high” side of the lap joint—where the sealant 180 connects the edge 170 to the top surface 162 of the base membrane 160. Accordingly, as seen in FIG. 8, the left side would be considered the high side and only the light 132L is illuminated. In other embodiments, the lights could be illuminated in an alternating manner to determine by the controller 152 which light provides a more distinct shadow, thus eliminating the need for user input in this regard.

The camera 140 generates the vision signal 142 that is received by the controller 152 so as to determine the area where sealant is to be dispensed. The controller 152 may employ a machine-vision program compatible with the camera 140. The program expects a generally straight line that is within a certain range of orientation angles (plus or minus 20 degrees) relative to the direction of travel. All other features may be ignored by the vision program. Even if there is a small amount of large-radius curvature in the lap joint edge, in the small view frame of the camera, the edge will be detected as a straight line. In some embodiments, the machine vision system runs at twenty frames per second. With each frame, it sends the position (relative to the view-frame center) and angle (relative to the direction of travel) of the detected edge to the controller via a serial buffer system.

Upon receipt of the vision signal 142 the controller 152 generates corresponding input so as to move the drive wheels 26 in the desired direction at the desired speed. As a result, the dispenser 10 may be configured to dispense material in advance of the drive wheel rotation direction (to the left in FIG. 1) or behind the drive wheel rotation direction (to the right in FIG. 1). It is believed that by dispensing the material in advance of the drive wheels, the dispenser will better be able to more accurately and correctly control the drive wheels to accommodate problems or deviations encountered in the membrane positioning. However, the dispenser may be operated in an opposite direction if a particular application is better suited to having the nozzle trail the direction of the drive wheel's rotation. In any event, the controller generates input drive signals 30A and 30B so as to independently control the drive wheels 26A and 26B.

Accordingly, input from the vision system allows for the entire chassis to be “coarsely” moved in relation to where the seam is positioned. Together the position system 110 and the drive wheels 26A,B use the angle and location of the lap joint edge measured by the detection system 130, and these measurements are the inputs for the controller 152 which employs a multi-input single-output (MISO) system to minimize error in the two measurements. The correction from the controller is added to the wheel opposite the offset or angle that needs correction. If the overrunning clutches were to be eliminated from the design, the correct signal would also be subtracted from the opposite wheel, enabling higher-precision control. In the present embodiment, the controller 152 updates the wheel motor(s) at a slower rate than the nozzle motor.

In the embodiment shown in FIGS. 1-3, the motor 116 used for positioning the nozzle 112 at the output of the caulk dispenser also receives the angle measurement from the vision system and works to minimize the error. In some embodiments a moving-average filter may be used to minimize noise from the vision system and smooth the motor's response. The motor design allows for a range of 1 inch of error correction without any steering control.

To complement the “coarse” positioning obtained through adjusting the speed of the drive wheels, the controller 152 generates a nozzle position motor signal 126 so as to control operation of the position motor 116. Based upon the input received from the vision signal 142, the position motor moves the nozzle linkage 118 and in turn the collar 120 so as to control the position of the tip 114 with respect to the shadow 176 so as to finely adjust the position of the tip with respect to the edge 170 so as to further position the placement of the sealing material with respect to the edge 170. As a result of the coarse and fine control of the position of the nozzle 112, a bead of sealant material may be precisely placed along the edge 170 in such a manner that it contacts both membranes and ensures a high quality seal therebetween.

Skilled artisans will appreciate that the sealant dispenser can operate virtually autonomously by operating the drive wheels and the nozzle position motor in conjunction with the dispensing of the sealant material by control of the plunger assembly 80 and, in particular, by operation of the plunger motor 92. Operation of the plunger motor 92 is confirmed by the linear encoder 98 and its corresponding encoder signal 100. This is done to ensure that a proper amount of sealant is being dispensed at the desired rate. The controller is able to adjust the dispense rate based on the speed of the chassis. Skilled artisans will further appreciate that the vision system may monitor the amount or quality or size of the bead being dispensed and adjust operational parameters accordingly.

In the embodiment shown in FIGS. 4-6, the motor used for positioning the nozzle 212 at the output of the caulk tube also receives the angle measurement from the vision system and works to minimize the error. In some embodiments, a moving-average filter may be used to minimize noise from the vision system and smooth the operation of the position motor 220.

To compliment the “coarse” positioning obtained through adjusting the speed of the drive wheels, the controller 152 generates a nozzle position motor signal 222 so as to control operation of the position motor 220. The caulk tubes, which may be carried side-by-side in the tray, are placed so that one of the tube's nozzles is placed in a position adjacent to or in almost touching contact with the membrane surface. The other nozzles may be positioned away from the membrane surface. The caulk tubes may be positioned in close proximity to or in almost touching contact with the membrane surface and are viewable by the camera 140. In either configuration of the caulk tube placement and based upon the input received from the vision signal 142, the position motor moves the tray 224 side to side (perpendicular to the travel of the dispenser) so as to control the position of the tip 214 with respect to the shadow 176 so as to finely adjust the position of the tip with respect to the edge 170 so as to further position the placement of the sealing material with respect to the edge. This fine positioning helps to accommodate the fine oscillations of where the caulk should be placed. The motor 220 allows up to 1½″ inches of lateral movement in either direction, but in most embodiments, it is believed that only about ½″ of lateral movement in either direction will be needed. As a result of the coarse and fine control of the position of the nozzle 212, a bead of sealant material may be precisely placed along the edge 170 in such a manner that the material contacts both membranes and ensures a high-quality seal therebetween.

As with the dispenser 10, the dispenser 10′ with the nozzle position system 110′ may operate virtually autonomously by operating the drive wheels and the position motor in conjunction with the dispensing of the sealant material by control of the plunger assembly 80 and in particular by operation of the plunger motor 92. As in the other embodiment, operation of the plunger motor 92 is confirmed by the linear encoder 98 and its corresponding encoder signal 100. This is done to ensure that a proper amount of sealant is being dispensed from the caulk tubes at the desired rate. The controller is able to adjust the dispense rate based on the speed of chassis. Skilled artisans will further appreciate that the vision system may monitor the amount, quality, or size of the bead being dispensed and adjust operational parameters accordingly.

The advantages of the present invention are readily apparent. First, the dispenser 10 automatically dispenses a uniform amount of sealant in a designated area. The dispenser is capable of automatically adjusting the nozzle position so that is dispenses material based upon an observed phenomenon. This automatic adjustment comprises a coarse adjustment and a fine adjustment. The coarse adjustment is attained by controlling drive wheels that propel the dispenser and the fine adjustment is attained by controlling a position of the nozzle as it dispenses the sealant. The dispenser is further advantageous in that a predetermined distance can be input into the dispensing system along with a rate of travel and a rate at which the sealant is dispensed. This allows for a substantially autonomous method of sealing two pieces of material to one another. This allows for minimal waste and time-saving operation.

Further advantages of the present invention include the ability of the dispensing system to lay down a uniformly sized bead which may be anywhere from ⅛″ to ½″ wherein the bead is laid down independent of the dispenser's travel speed, with no gap between the bead and the joint and no forced spreading of the bead. The dispenser may be self-propelled at the speed of at least 120 inches per minute and wherein the speed may be as much or more than 240 inches per minute. The system provides for a guide or tracking system which senses departures from a seam and moves the applicator nozzle accordingly. The dispenser may be configured to work on flat or sloped roofs without tipping or veering significantly. And the dispenser may be configured to accommodate sealant contained in chubs or pails so as to seal at least at 100 foot seam or more. The dispenser system may be configured for easy and quick replacement of the dispensing material from the chassis with no tools other than to cut open the packaging. Embodiments of the dispenser may provide for a manual dispense feature to force dried sealant out of the nozzle and also for a quick-nozzle replacement feature.

Various modifications and alterations that do not depart from the scope and spirit of this invention will become apparent to those skilled in the art. This invention is not to be duly limited to the illustrative embodiments set forth herein.

What is claimed is:

1. A sealant dispenser comprising:
(i) a chassis adapted to carry a supply of sealant dispensable through a nozzle;
(ii) at least one drive wheel to directionally propel said chassis; and
(iii) a detection system carried by said chassis to determine a location to dispense sealant through said nozzle and controlling direction of said at least one drive wheel to position said nozzle.

2. The dispenser according to claim 1, further comprising:
a nozzle position system carried by said chassis and coupled to said nozzle, said nozzle position system receiving input from said detection system to control position of said nozzle while said at least one drive wheel propels said chassis.

3. The dispenser according to claim 2, comprising:
two drive wheels to propel said chassis, wherein said detection system selectively controls each said drive wheel to position said chassis and said nozzle position system to control position of said nozzle.

4. The dispenser according to claim 2, wherein said detection system comprises:
a camera to view the location and observe a selected phenomenon and generate a signal to control operation of at least one of said at least one drive wheel and said nozzle position system.

5. The dispenser according to claim 2, wherein said detection system comprises:
a camera viewing a surface or surfaces to receive a dispensed sealant and determining whether a predetermined phenomenon is present or not and controlling operation of at least one of said nozzle position system and said at least one drive wheel.

6. The dispenser according to claim 5, wherein said detection system further comprises:
at least one light mounted to said chassis and directed toward the surface or surfaces, wherein said predetermined phenomenon is a shadow which is where the dispensed sealant is to be placed.

7. The dispenser according to claim 5, further comprising:
a dispensing system associated with said supply of sealant, said dispensing system comprising:
a plunger assembly having a plunger motor which selectively dispenses sealant through said nozzle, wherein said plunger motor is activated based on input from at least said detection system.

8. The dispenser according to claim 7, further comprising:
at least one bumper sensor coupled to said chassis, wherein activation of said bumper sensor deactivates said plunger motor and said at least one drive wheel.

9. The dispenser according to claim 7, further comprising:
at least one cliff sensor coupled to said chassis, wherein activation of said cliff sensor deactivates said plunger motor and said at least one drive wheel.

10. A method for dispensing sealant, comprising:
(i) observing with a detection system a phenomenon in an area that receives a sealant;
(ii) automatically moving a chassis that carries the sealant; and
(iii) dispensing the sealant in the area by automatically moving said chassis relative to the observed phenomenon.

11. The method according to claim 10, further comprising:
(i) moving said chassis with at least one drive wheel so as to directionally move said chassis toward the observed phenomenon; and
(ii) dispensing the sealant through a nozzle that is automatically positioned based on the observed phenomenon.

12. The method according to claim 11, further comprising:
(i) viewing the observed phenomenon with a camera to generate a signal; and
(ii) processing said signal to adjust automatically moving said chassis and dispensing the sealant along the area of the observed phenomenon.

13. The method according to claim 12, further comprising:
illuminating the area that receives the sealant so as to generate a shadow detectable by said camera.

14. The method according to claim 13, further comprising:
(i) associating at least one driven wheel with said chassis in a coarse manner in relation to the shadow; and
(ii) associating a motorized mechanism with said nozzle to automatically position said nozzle in a fine manner in relation to the shadow.

15. A method for dispensing a sealant, comprising:
(i) observing with a detection system a phenomenon in an area that receives a sealant;
(ii) automatically moving a chassis that carries the sealant based on a signal generated by said detection system; and
(iii) automatically moving a nozzle that dispenses the sealant based on the signal generated by said detection system.

16. The method according to claim 15, further comprising:
moving said chassis with a pair of independently driven wheels, wherein each said driven wheel is moved based on the signal generated by said detection system.

17. The method according to claim 16, further comprising:
automatically dispensing the sealant based on at least the signal generated by said detection system or a dispense rate input into a dispensing system carried by said chassis.

18. The method according to claim 17, further comprising:
illuminating the area with light to enhance observation of the phenomenon.

19. The method according to claim 17, further comprising:
detecting an interfering force on said chassis and stopping dispensing of the sealant and operation of said pair of independently driven wheels.

20. The method according to claim 17, further comprising:
detecting a drop of said chassis and stopping dispensing of the sealant and operation of said pair of independently driven wheels.
